(19) United States
(12) Patent Application Publication
(10) Pub. No.: US 2003/0185002 A1
(43) Pub. Date: Oct. 2, 2003

(54) Lightweight steel frame lamp assembly

(76) Inventor: Frank Chen, Taipei (TW)

Correspondence Address: FRANK CHEN, P.O. BOX 26-757, TAIPEI, R.O.C. 106, TW

(21) Appl. No.: 10/112,893

(22) Filed: Mar. 29, 2002

(51) Int. Cl. F21S 4/00

(52) U.S. Cl. 362/225; 362/147; 362/260

(57) ABSTRACT

A lightweight steel frame lamp assembly comprises a rack, a lamp, and a composite shell. The rack has a circuit member including ballast and lamp sockets. The lamp are assembled between two opposite sockets and powered through the circuit member. The composite shell is detachably assembled to the rack. Therefore, the lightweight steel frame lamp assembly can be disassembled into smaller components for the convenience of transportation and storage.

### FIELD OF THE INVENTION

The present invention relates to a composite lamp assembly, especially to a lamp assembly feasibly mounting on lightweight steel frame and having detachable structure for convenience of transportation and storage.

### BACKGROUND OF THE INVENTION

The lighting utility becomes increasingly important for illumination and decoration purposes. Therefore, various types of lamps such as ceiling lamp, hanging lamp, desktop lamp, table lamp and stand lamp are extensively developed.

FIG. 1 shows a conventional lightweight steel frame lamp assembly mounted on a ceiling. The lamp assembly 10a is mounted on a lightweight steel frame and comprises a shell 12a, a plurality of light-reflection plates 13a in the shell 12a and a plurality of lamps 14a provided among the plurality of light-reflection plates 13a. The lamps 14a are connected to an electric power source through a socket, a starter and a ballast.

However, the above-mentioned lightweight steel frame lamp assembly generally has fixed structure. Therefore, the conventional lightweight steel frame lamp assembly occupies considerable space and has difficulties in transportation and storage.

### SUMMARY OF THE INVENTION

It is the object of the present invention to provide a lamp assembly feasibly mounting on lightweight steel frame and having detachable structure for convenience of transportation and storage.

To achieve above object, the present invention provides a lightweight steel frame lamp assembly comprising a rack, a lamp, and a composite shell. The rack has a circuit member including ballast and lamp sockets. The lamp are assembled between two opposite sockets and powered through the circuit member. The composite shell is detachably assembled to the rack. Therefore, the lightweight steel frame lamp assembly can be disassembled into smaller components for the convenience of transportation and storage.

The various objects and advantages of the present invention will be more readily understood from the following detailed description when read in conjunction with the appended drawing, in which:

### BRIEF DESCRIPTION OF DRAWINGS

FIG. 1 shows a perspective view of prior art lamp assembly;

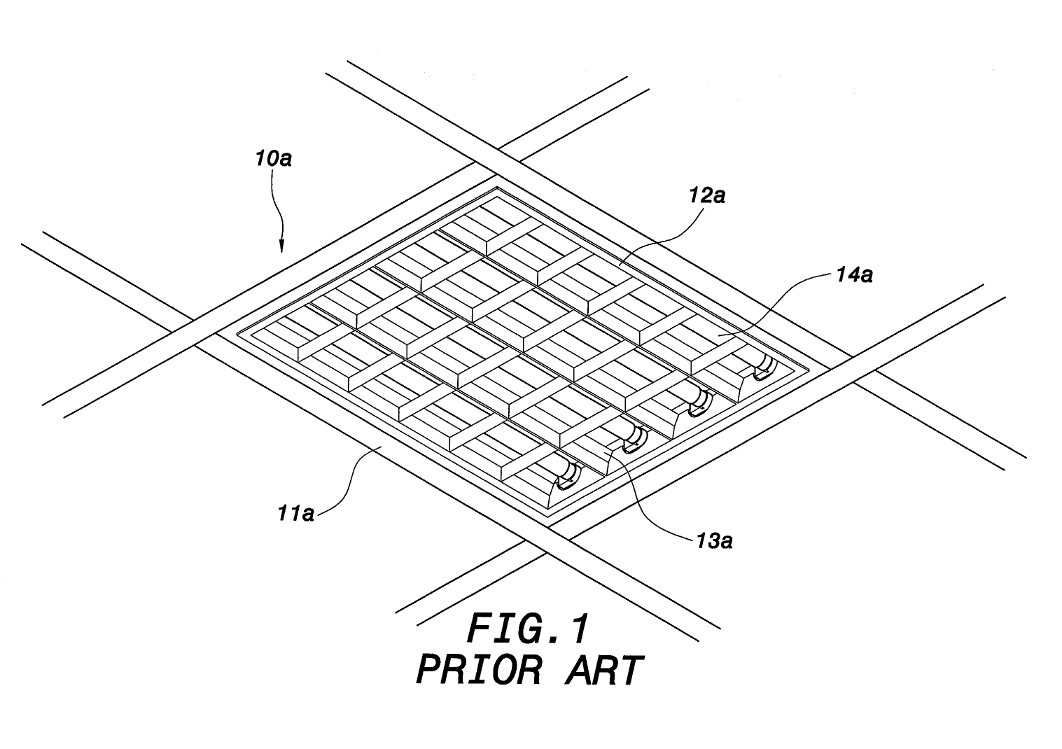

FIG. 2 shows an exploded view of the present invention;

FIG. 3 shows a perspective view of the present invention;

FIG. 4 shows a sectional view of the present invention;

FIG. 5 shows that the lamp assembly of the present invention being assembled to a lightweight steel frame.

### DETAILED DESCRIPTION OF THE INVENTION

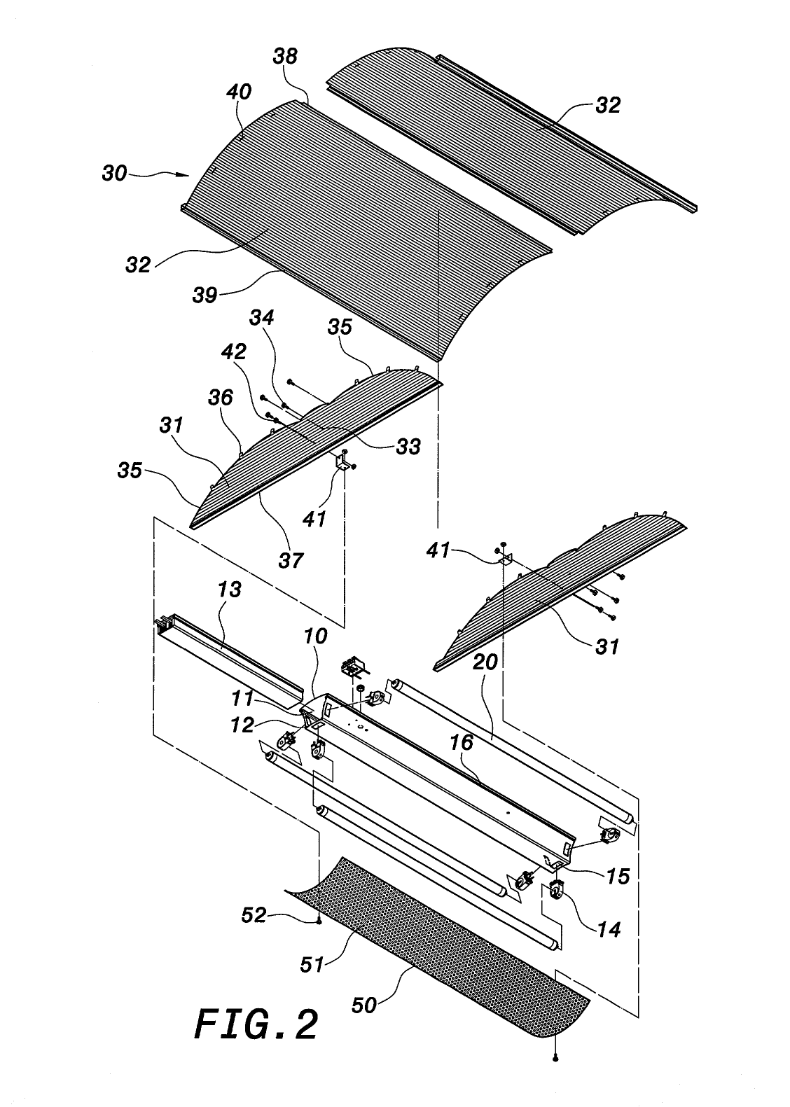

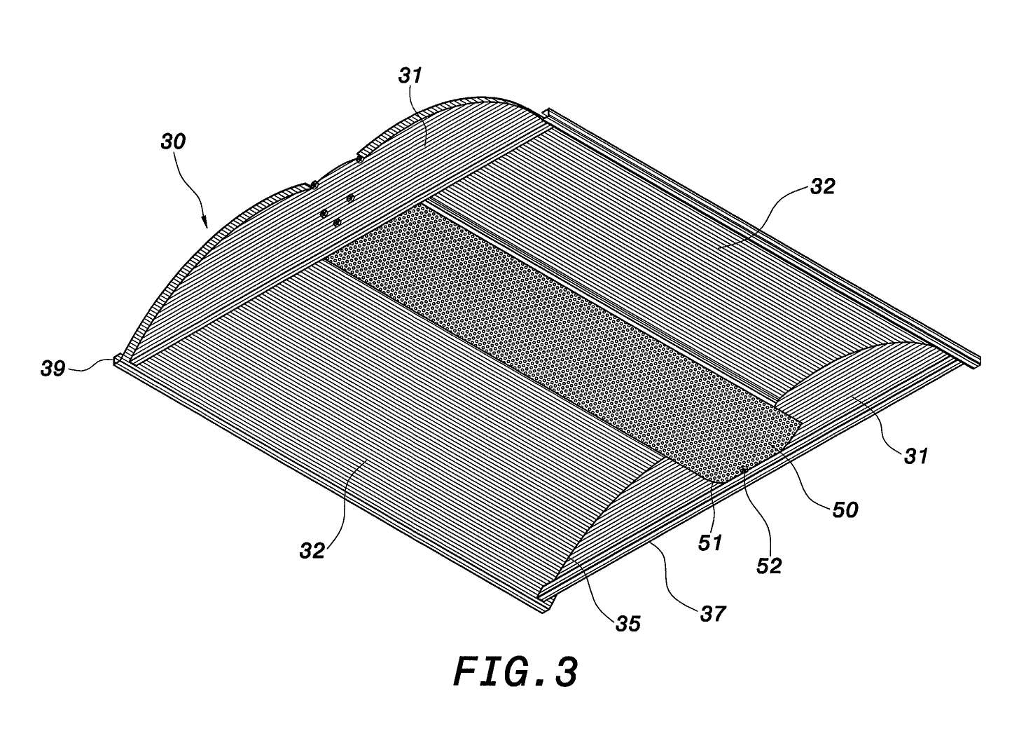

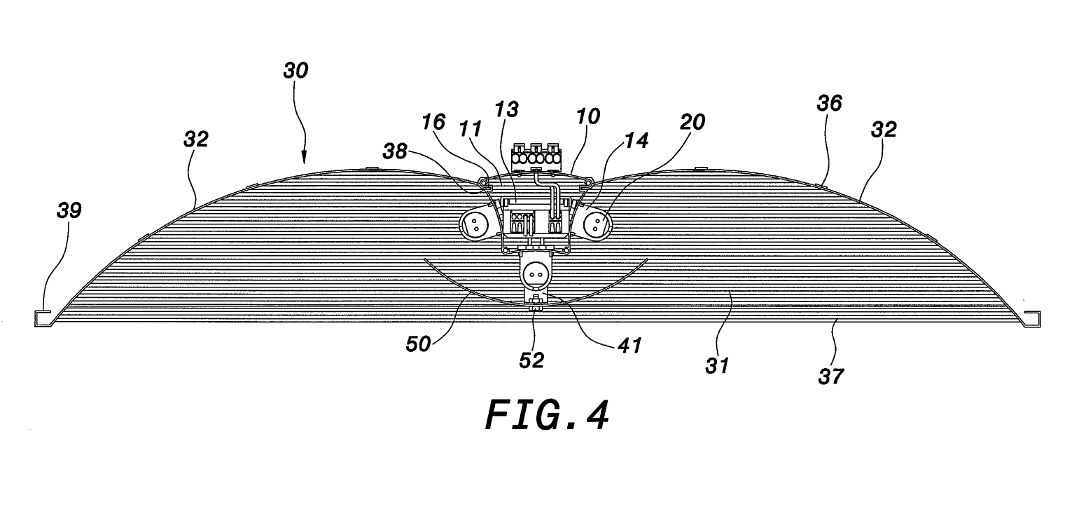

As shown in FIGS. 2, 3 and 4, the present invention is intended to provide a lightweight steel frame lamp assembly, which comprises at least a rack 10, a lamp 20 and a composite shell 30. The rack 10 is a hollow beam-shaped body made by aluminum extrusion and has a receiving space 11 therein. The receiving space 11 has open end on each end thereof. The rack 10 has a plurality of threaded holes 12 and two embedding grooves 16 on two top lateral sides thereof. The two embedding grooves 16 extend along a lengthwise direction of the rack 10.

The rack 10 is used to accommodate ballast 13 and sockets 14 for providing electric power to the lamp assembly. The ballast 13 is preferably mounted in the rack 10. However, the ballast 13 can be also provided outer the rack 10 or at other location. The sockets 14 are arranged outside the rack 10 in pair and have number corresponding to the number of the lamp 20. More particularly, the rack 10 has two mounting holes 15 near the two distal ends thereof and the sockets 14 can be mounted on the mounting holes 15 by snap fit. Moreover, a circuit (not shown) is connected between the socket 14 and the ballast 13.

The lamp 20 can be fluorescent lamp or other lamps and assembled to the two sockets 14 on both ends thereof. The number of the lamp 20 can be varied according to practical need. The lamp 20 is powered through the ballast 13 and the socket 14.

The composite shell 30 is arranged outside the rack 10 and the lamp 20 and has two lateral plates 31 and two cover plates 32. The two lateral plates 31 are made of aluminum plates and each has a plurality of through holes 33 corresponding to the threaded holes 12 on one end of the rack 10. Therefore, the two lateral plates 31 can be detachably assembled to both sides of the rack 10 by tightening a plurality of screws 34 through the through holes 33 and the threaded holes 12. Each of the lateral plates 31 has two curved sides 35 with a plurality of insertion plates 36. Each of the lateral plates 31 has an L-shaped bent edge 37 on lower side thereof for enhancing strength thereof.

The cover plates 32 are made of aluminum plates and each has a curvature corresponding to the curvature of the curved side 35. Each of the cover plates 32 has a panel-shaped embedding plate 38 on one side thereof and a plurality of U-shaped bent edges 39 opposite to the embedding plate 38 for enhancing strength thereof. Each of the cover plates 32 has a plurality of insertion holes 40 on two opposite sides thereof and corresponding to the insertion plates 36.

The cover plate 32 is placed on the curved sides 35 with the embedding plate 38 on one side thereof being embedded into one embedding groove 16 such that the two cover plates 32 are assembled to the rack 10. Moreover, the insertion plates 36 of the lateral plates 31 are inserted into the insertion holes 40 of the cover plates 32, and the insertion plates 36 bent to assemble the lateral plates 31 and the cover plates 32 into the composite shell 30.

The lateral plate 31 has a retaining stage 41 at center section thereof and the retaining stage 41 is screwed to inner side of the lateral plate 31 by screw 42. A mesh hood 50 is provided between the two lateral plates 31 and has a plurality mesh holes 51 thereon. The mesh hood 50 is bent to curved shape and covers bottom of the lamp 20. A plurality of screws 52 fix the mesh hood 50 to the retaining stages 41 such that the mesh hood 50 is retained between the two lateral plates 31 and the light of the lamp 20 emits through the mesh hood 50.

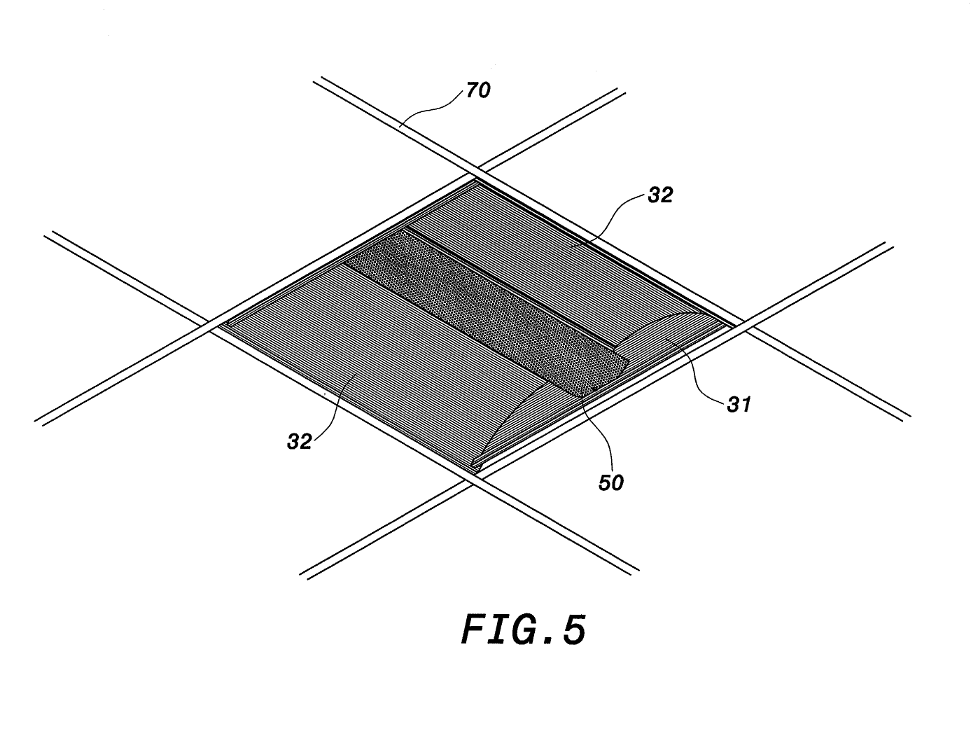

As shown in FIG. 5, the lightweight steel frame lamp assembly of the present invention is mounted on a lightweight steel frame 70 and the lamp 20 thereof provides lighting function. The lightweight steel frame lamp assembly of the present invention has detachable design, wherein the rack 10 and the shell 3 are detachably assembled through the screws 34, the embedding plate 38 and the embedding grooves 16. Moreover, the lateral plates 31 and the cover plates 32 of the composite shell 30 are detachably assembled through the insertion holes 40 and the insertion plates 36. The lightweight steel frame lamp assembly of the present invention can be disassembled into smaller components for the convenience of transportation and storage.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A lightweight steel frame lamp assembly, comprising at least:
a rack having a circuit member;
a lamp arranged on the rack and powered through the circuit member; and
a composite shell being detachably assembled to the rack.

2. The lightweight steel frame lamp assembly as in claim 1, wherein the rack has a plurality of threaded holes on both ends thereof and the composite shell has a plurality of through holes corresponding to the threaded holes, the composite shell being detachably assembled to the rack by tightening a plurality of screws through the through holes and the threaded holes.

3. The lightweight steel frame lamp assembly as in claim 1, wherein the rack is of hollow shape with a receiving space therein, the receiving space has open end on each end thereof, the circuit member being placed within the receiving space.

4. The lightweight steel frame lamp assembly as in claim 1, wherein the circuit member is placed outside the receiving space.

5. The lightweight steel frame lamp assembly as in claim 1, wherein the circuit member comprises a ballast and a plurality of sockets arranged in pair outside the rack, the lamps having two end connected to corresponding sockets.

6. The lightweight steel frame lamp assembly as in claim 5, wherein the rack has a plurality of mounting holes on which the sockets are mounted by snap fit.

7. The lightweight steel frame lamp assembly as in claim 1, wherein the rack has at least one embedding groove and the composite shell has at least one embedding plate fit with the embedding groove.

8. The lightweight steel frame lamp assembly as in claim 1, wherein the composite shell has two lateral plates screwed to both ends of the rack and two cover plates, each of the lateral plates having two curved sides with a plurality of insertion plates, each of the two cover plates being bent to have curvature same as that of the curved side and having a plurality of insertion holes on two opposite sides thereof and corresponding to the insertion plates, each of the two cover plates being placed on the two curved sides with the insertion plates inserting into corresponding insertion holes, the insertion plates then being bent to assemble the lateral plates and the cover plates into the composite shell.

9. The lightweight steel frame lamp assembly as in claim 1, further comprising a mesh hood on the composite shell and outside the lamp.
